(19) United States
(12) Patent Application Publication
(10) Pub. No.: US 2010/0054242 A1
(43) Pub. Date: Mar. 4, 2010

(54) Method, apparatus and computer program to generate a unique node identifier

(75) Inventors: Ian Justin Oliver, Soderkulla (FI); Jukka Honkola, Espoo (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/231,291

(22) Filed: Aug. 28, 2008

(51) Int. Cl. H04L 12/56

(52) U.S. Cl. 370/389

(57) ABSTRACT

A method includes receiving a request for a node identifier, the request including a first information element. In response, the method further includes generating a unique node identifier that includes a plurality of second information elements and the first information element; and responding to the request with the generated unique node identifier. Also disclosed are apparatus for performing the method, as well as a computer program embodied on a computer-readable media for executing the method.

### TECHNICAL FIELD

The exemplary and non-limiting embodiments of this invention relate generally to the generation of a unique identifier for a node, such as one bidirectionally coupled with an information-containing system, such as the semantic web.

### BACKGROUND

Various abbreviations that appear in the specification and/or in the drawing figures are defined as follows:
GSM global system for mobile communication, a mobile telecommunication protocol
3G third generation, descriptive of a class of mobile telecommunication protocols
3GPP 3G positioning protocol (part of the 3G protocol)
GPS global positioning system
IP internet protocol
RDF resource description framework
SIB semantic information broker
SIM subscriber identity module
SSAP smart space application protocol
TCP transmission control protocol
UUID universal unique identifier
URI uniform resource identifier
WLAN wireless local area network
WWW world wide web
XML extensible markup language

The “Semantic Web” in its current form represents information that is either static or monotonically changing. It has its roots in the WWW and thus takes on a “web-wide” persona. The information and ontologies used have standard web-wide semantics grounded in generally accepted real-world concepts.

Much of the usage of information, that will invariably become part of the Semantic Web, will be personal and/or local. The semantics, structure and adherence to real-world concepts will be grounded by the local users of that information, thus resulting in many localized Semantic Webs.

These local Semantic Webs will contain information that is highly dynamic, non-monotonically changing, adhering loosely (if at all) to their stated ontologies, or not to any standardized, written and commonly understood ontology, and will behave and be reasoned about according to localized, non-standard and non-intuitive logics.

The dynamicity and monotonicity of information in and forming the Semantic Web will vary depending upon locality and be organized according to person, usage, etc., as what may be termed as “spaces” or, more descriptively, as “SmartSpaces”. Of particular interest herein are such small, localized information or knowledge spaces by which persons, via autonomous ‘agents’, interact through control-flow-free mechanisms.

A problem that arises is how to generate unique and meaningful identifiers for nodes or agents in a SmartSpace-based system, such that these unique identifiers can be read (through decryption if necessary) for information that cannot be readily faked or misrepresented. The information derived from such identifiers may be used, for example, for identification, trust and policy enforcement purposes.

### SUMMARY

The foregoing and other problems are overcome, and other advantages are realized, by the use of the exemplary embodiments of this invention.

In a first aspect thereof the exemplary embodiments of this invention provide a method that includes receiving a request for a node identifier, the request including a first information element; in response, generating a unique node identifier that includes a plurality of second information elements and the first information element; and responding to the request with the generated unique node identifier.

In a further aspect thereof the exemplary embodiments of this invention provide a computer-readable memory media that stores a computer program instructions, where execution of the computer program instructions results in the performance of operations that comprise receiving a request for a node identifier, the request including a first information element; in response, generating a unique node identifier that includes a plurality of second information elements and the first information element; and responding to the request with the generated unique node identifier.

In another aspect thereof the exemplary embodiments of this invention provide an apparatus that comprises a receiver configured to receive a request for a node identifier, the request including a first information element; a generator configured to respond to the received request to produce a unique node identifier that includes a plurality of second information elements and the first information element; and a transmitter configured to send the generated unique node identifier.

### BRIEF DESCRIPTION OF THE DRAWINGS

In the attached Drawing Figures:

FIG. 1 illustrates an exemplary architecture within which the embodiments of this invention may be implemented.

FIG. 2 depicts the overall behavior of a system that includes the exemplary embodiments of this invention.

FIG. 3 shows an example implementation of the system.

FIG. 4 shows an exemplary message sequence flow between the units shown in FIG. 1 and FIG. 3.

FIG. 5 is an example of a Sedvice SmartSpace architecture that is useful in providing a context and technological environment for the exemplary embodiments depicted in FIGS. 1-4.

FIG. 6 is a logic flow diagram that illustrates the operation of a method, and a result of execution of computer program instructions, in accordance with the exemplary embodiments of this invention.

### DETAILED DESCRIPTION

Reference may be had to a publication entitled: Personal Semantic Web Through A Space Based Computing Environment”, by Ian Oliver and Jukka Honkola, in proceedings: Middleware for the Semantic Web, Second IEEE International Conference on Semantic Computing, Santa Clara, Calif., USA, Aug. 4-7, 2008, which is incorporated by reference herein in its entirety.

The generation of a unique identifier can be achieved by a number of means, such as by randomly generating unique identifiers, or by using serial numbers of hardware. At present, currently known generation methods do not provide for encryption of such an identifier (which is typically random in its information content).

The exemplary embodiments of this invention pertain to the generation of unique identifiers for various multiple agents or nodes, such as multiple agents or nodes in a SmartSpace-based system. The exemplary embodiments also pertain to other use cases and scenarios, such as RDF blank node identifier generation for the secure inclusion of additional information.

These exemplary embodiments combine various identifier generation techniques and apparatus with the inclusion of random number and unique identifier generation techniques, as well as internal information about a host application, to produce a unique identifier which may also contain semantic information if desired.

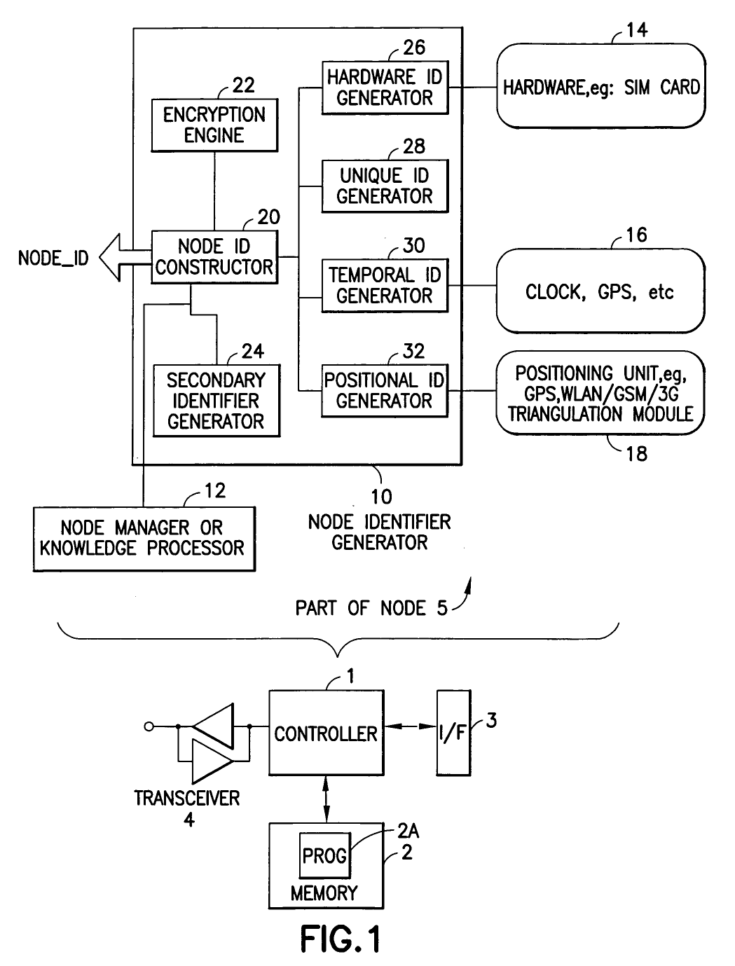

In certain exemplary embodiments it should be noted that the described identifier generation code returns an UUID4 number via a unique ID generator component (item 28 in FIG. 1). This particular approach is made for simplicity, and is not to be construed as a limitation. For example, also described is an example of the generation of a much richer and robust identifier.

General reference to UUID may be made to, for example, RFC 4122, “A Universally Unique Identifier (UUID) URN Namespace”, P. Leach et al., July 2005.

Also described is a scenario in which a node identification may be used within the context of an RDF graph for uniquely identifying “blank nodes” with a meaningful unique identifier, which may carry meta-information in a secure form.

General reference with regard to RDF may be made to, for example, a document entitled “RDF Primer”, W3C Recommendation 10 Feb. 2004, eds. F. Manola et al. (www.w3.org).

In the context of these exemplary embodiments a “knowledge processor” contains one or more nodes to facilitate connection to a Space, e.g., a SmartSpace. A SmartSpace is constructed from a number of SIBs which represent and perform the processing of the SmartSpace.

A node joins a SmartSpace by passing a set of credentials which are then evaluated by a SIB. If successful the node is enabled to join the SmartSpace, and the ID of the node is noted for subsequent transactions between the node and any SIB in that SmartSpace. Such transactions between the node and the SmartSpace include information insertion, retraction, querying and subscriptions, as described more fully below with respect to FIG. 5.

There is no restriction as to whether each node must present a unique identifier, although a SmartSpace may decide to degrade the trust and functionality if two or more nodes attempt a join with the same identifier.

In order to provide further context for the exemplary embodiments of this invention, reference may be made to FIG. 5.

The inventors have developed a system, which may be referred to as “Sedvice”, that takes conventional agent, blackboard and publish/subscribe concepts and reimplements them in a lightweight manner suitable for small, mobile devices. These agents, termed “knowledge processors” (KPs), operate autonomously and anonymously by sharing information through spaces. These spaces contain a store of information to which the KPs have access and can change at will, processing capabilities for reasoning, modifying and analyzing that information, as well as security and policy functions.

The Sedvice system assumes that information is shared through localized (potentially) personal spaces; that the information can be highly dynamic (changing), and that the information has a semantics primarily given through the interpretation of the information by any given KP. No control flow mechanism need be present, and KPs may share information concerning how external communication, synchronization and coordination can be achieved.

The Sedvice architecture at its simplest is a publish/subscribe system having distributed KPs. Each KP includes a user interface (UI), as well as the logic and/or internal workings of the knowledge processor and nodes. Spaces contain information brokers (known as SIBS), an information store and reasoners. FIG. 5 shows the relationship between these various elements.

A KP is considered as a composite structure which is capable of running on a single device, e.g., a mobile device (such as a wireless communication device), a personal computer or a sensor, as a few examples. A particular device may host more than one KP depending on, for example, the operating system and the available memory. The UI is not required in all cases and, if present, may be very simple in nature, e.g., an LCD display, a single button. A node is the part of the KP which contains the logic and functionality to connect to some Space, including the logic for parsing messages and pointers to subscription handlers between the KP and the Space. A node may potentially connect to more than one Space at a time, thus distributing and synchronizing operations across all connected Spaces. Alternatively a KP may contain more than one node.

The basic functionality for manipulating information by a node is given by the following operations:
Insert: insert information atomically
Retract: remove information atomically
Query: synchronously (blocking) query; returns information
Subscribe: asynchronously (persistent, non-blocking) set up a subscription for a given query
Unsubscribe: terminate processing of a given subscription.

A Space at its simplest contains a single method for listening on some transport protocol (e.g., a TCP socket interface), the logic for processing messages, policy/security and handling subscriptions and the information store itself. Additionally a set of “reasoners” may also be present, which may be considered to be (effectively) nodes operating in a restricted environment.

The reasoner nodes operate subsequent to all the pending requests for insertion and retraction of information being completed, and process the information in the information store. This processing may be truth maintenance, belief revision, information consistency management, information creation, or any other atomic processing required by that space. Reasoner nodes are scheduled according to priority classes, with the reasoner nodes in each class running concurrently, and all completing after the next priority class is scheduled. One reason for providing priority classes of reasoners is to control the ordering to avoid a situation where two reasoners may interact in unpredictable ways if run concurrently. A reasoner node may be scheduled to run more than once during one reasoning cycle if it exists in two different priority classes.

In a present, non-limiting implementation the SIB stores information as a graph, and conforms to the rules of RDF. The basic operations performed upon the information store are insertion of a graph, retraction of a graph, querying, and subscription for information. Insertion and retraction may be combined into a single transactional structure in order to perform an atomic update through the atomic application of a retract and an insert operation.

Queries are synchronous in nature, while subscriptions are persistent and asynchronous in nature and have a lifetime governed by the creating node. In one exemplary implementation of the system two types of query formats are admitted: triple queries and WQL queries.

No attempt is made by the Space to enforce consistency or integrity of information according to the stated ontologies (through the RDF typeOf relation). Internal reasoning nodes may be present which perform this activity if the Space has been instantiated in this manner. Information is explicitly semi-structured and may take on any form that a KP inserts/retracts. While certain typing constructs and namespaces may be present (if this information is inserted), these do not mean that a node querying for that information will necessarily interpret that information according to the implied ontology. The semantics of the information is interpreted by the reader, merely implied by the writer, and is grounded in the real-world context of the node (any two given KPs may disagree about the ultimate interpretation of the information).

The Space provides further functionality regarding the joining and leaving of KPs/Nodes, as well as policy management. KPs have a set of credentials which are passed during the join operation.

The dual of the KP/node instantiated leave and join operations are Space instantiated invite and remove operations. These operations are not necessarily provided by every Space, nor understood by every KP/node.

Connectivity is provided through a set of “listeners” that provide access via any given specified protocol. One suitable protocol is TCP/IP through standard socket mechanisms, although other protocols can be used to provide, for example, a Bluetooth™ enabled listener, or a listener that uses HTTP/S. Listeners can provide preprocessing of the incoming messages if necessary, for example, with Bluetooth™ profiles. Any number of listeners may be provided at any time, although it is assumed that there is always at least one present.

A Space is constructed from a number (at least one) of the SIBs which contain the aforementioned schedulers, management information, listeners and information store. A Space is represented by these SIBS, and the total possible connectivity methods are defined by the distributed union of all the represented SIB listeners. The SIBs communicate internally to ensure and verify the membership and credentials of the KP/nodes that have joined that Space, which may connect via any listener and any SIB in that Space.

From the point of view of any KP, the information available is always the distributed union over the transitive closure of the routes between all the SIBs (each SIB contains routing tables to other SIBS), and within a given Space all of the SIBs are totally routable (but not necessarily totally connected).

Having thus provided an overview of one non-limiting type of environment in which the exemplary embodiments of this invention may be practiced, reference is now made to the basic architecture of the system that is shown in FIG. 1. A node 5 (which may be embodied in a mobile device, such as a wireless communication device) includes a node identifier generator component 10 that may include, or be interfaced with, a node manager or knowledge processor 12; some specific hardware 14, such as a SIM card; a time source 16, such as a clock or GPS system; and a positioning unit 18, such as a GPS or a WLAN/GSM/3G triangulation module. The node identifier generator component 10 may be configured to include all or a sub-set of a node ID constructor 20, an encryption engine 22, a secondary identifier generator 24, a hardware ID generator 26 (configured for coupling with the hardware 14), a unique ID generator 28, a temporal ID generator 30 (configured for coupling with the time source 16) and a positional ID generator 32 (configured for coupling with the positioning unit 18). Note that not all of these particular modules/units/functions may be present in a particular implementation, and furthermore that the node identifier generator component 10 may include other, additional modules/units/functions in some implementations. In other words, the architecture depicted in FIG. 1 is not intended to be viewed as limiting in any respect the exemplary embodiments of this invention.

Also shown in FIG. 1 are exemplary apparatus and components that may host the functionality of the node 5, including at least one controller 1, such as a computer or data processor, a computer-readable memory media, or memory 2, that stores a program of computer executable instructions (PROG) 2A, an interface (I/F) 3 for coupling with any needed hardware devices, such as the hardware 14, clock 16 and positioning unit 18 (if not internal to the node 5), and at least one transmitter/receiver (transceiver) 4 for bidirectional communication with other components of the Space, such as a SIB. In some embodiments the transceiver 4 may be a wired-type of transceiver adapted for communication through a cable or fiber optic network, while in other embodiments the transceiver 4 may be wireless-type of transceiver, such as one adapted for radio frequency (e.g., cellular, or WLAN, or mesh network, or WiMAX, or Bluetooth) or optical communications. Note that the various components of the node 5, such as the encryption engine 22, the constructor 20 and the various generators 24, 26, 28, 30 and 32 may be implemented entirely as software that forms a part of the program 2A, or as hardware circuits (e.g., dedicated encryption engine logic), or as a combination of software and hardware (and firmware).

During the construction of a message to be sent to a Space (e.g., a SmartSpace) a node identifier (ID) is needed. This is achieved by at least two mechanisms: creation of the ID and getting the ID. Both mechanisms return an ID in some suitable form, such as a string of bytes/characters, or in a more structured form such as an XML representation.

Both mechanisms take a parameter (or parameters if not expressed as a single parameter with structure) that is used during the final processing of the node identifier.

Technically, a create( ) is a wrapper for a get( ) that stores a completely new ID based upon triggering the generation mechanism. Both take the form:

Create(parameter):NodeID
Get(parameter):NodeID

If one were to embed this in some program:

Str var = Create(1)
Print “Id is = ”, var

the output may appear as follows:

Id is =0x38abc876d8e787ff,

which assumes the non-limiting case of a hexadecimal representation.

For a case of identifier embedding in a message, a typical message between the node 5 and a SIB, in the non-limiting case of the Sedvice SmartSpace described above with respect to FIG. 5, takes the form in XML:

```
<SSAP_message>
  <icv>ICV</icv>
  <node_id>ID</node_id>
  <space_id>ID</space_id>
  <transaction_id>ID</transaction_id>
  <transaction_type>INSERT</transaction_type>
  <message_type>REQUEST</message_type>
  <parameter name = “triples” type = “RDF-XML | RDF-M3”>
    STRING
  </parameter>
  <parameter name = “confirm”>TRUE | FALSE</parameter>
</SSAP_message>
```

A typical instantiation of this can be seen below in the exemplary SSAP message with the node ID highlighted:

```
<SSAP_message>
  <transaction_type>INSERT</transaction_type>
  <message_type>REQUEST</message_type>
  <transaction_id>62355249-9807-4c91-95ff-21640cebc266
  </transaction_id>
  <node_id>1ddcb584-96e4-49e1-a901-7e2cf1d1e642_bootHSS
  </node_id>
  <space_id>x</space_id>
  <parameter name = “triples” type = “rdf-m3”>
    <triple_list>
      <triple tag = “0”>
```

All communication between the node 5 and the SIB/SmartSpace may be performed in this manner, using the explicitly embedded node_id.

Discussed now in further detail are the constituent components of the node ID generator 10 shown in FIG. 1.

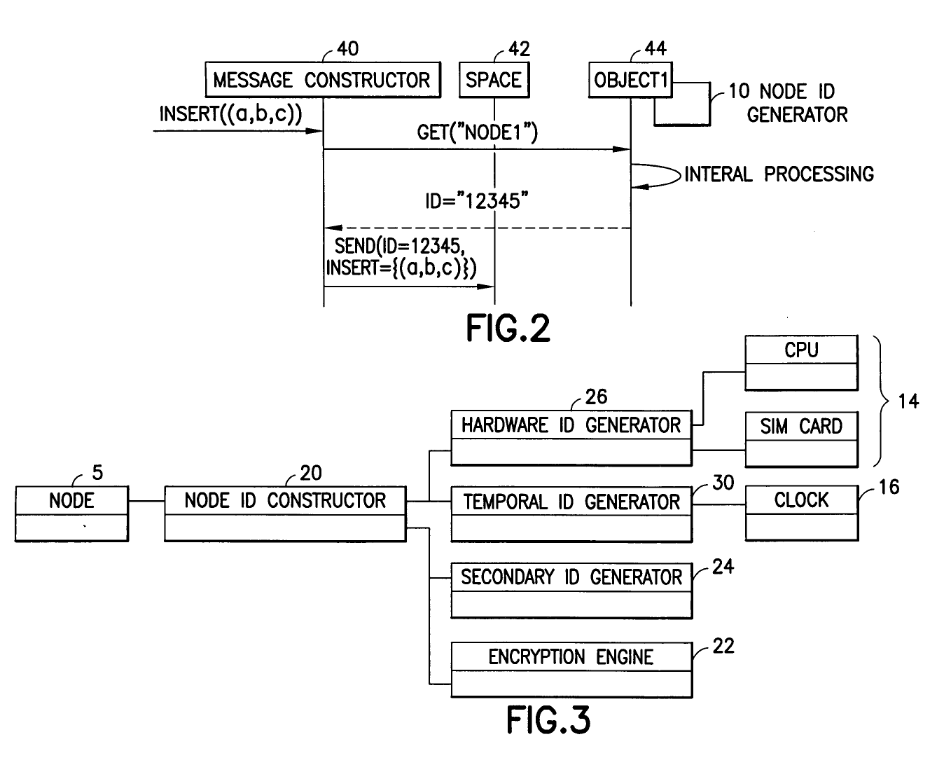

The primary interface is via the node ID constructor 20 which provides the create and get functions to the outside world, in this case the message constructor 40 (see FIG. 2) of the knowledge processor 12. The node ID constructor 20 provides coordination between these functional components and has the responsibility for storing any temporary and transient information related to the process, such as any passed parameters. The node ID constructor 20, if implemented in hardware, may include at least logic and persistent memory. Non-persistent memory may be used as well, so long as it can be reloaded from storage upon power-up or reboot. The storage may be located within-component or off-component using suitable storage technology, such as storing the information to a file and reloading from the file.

The encryption engine 22 encrypts the generated identifier before usage, and provides a mechanism for protecting the information stored within the identifier, if the identifier contains such information that could be used to ascertain certain aspects of the device and/or the hardware or software used for creating the identifier (e.g., the node 5). If the identifier is generated from a single unique source, for example UUID4, then the encryption engine 22 may not be needed. However, if the identifier is generated from a multiplicity of sources, such as other UUID standards or clocks, network addresses, and so forth, then the use of the encryption engine 22 is desirable, but not mandatory. In other words, the encryption engine 22 may be viewed as an optional component in a given implementation.

The encryption engine 22, if present, may use any suitable technology, such as a one-time pad or a public-private key. It may be assumed that the encrypted key can always be decrypted by a trusted recipient, and any information that the identifier contains can thus be read by the trusted recipient.

The secondary identifier generator 24 may be used to add any hard coded information into the key. Such information may be, by example, a serial number of the node identifier generator component 10. While node identifier generation may also be influenced by any passed parameters to the node ID constructor 20, the secondary identifier generator 24 may override this information, or it may add to this information. The secondary identifier generator 24 may be operated so that the information stored by this component is obtained from some other source.

The node manager or knowledge processor 12 may be located outside of the node ID generator 10, although information pertaining to the generation of the identifier can be obtained dynamically at run-time from hardware, software or other components, in particular the node manager 12 (which contains information about its run-time environment and which nodes/agents are running), or a particular node/knowledge processor itself.

The hardware ID generator 26 generates identifier information based upon reading some hardware component, such as the SIM card 14, or a CPU serial number, as two non-limiting examples.

The unique ID generator 28 is connected to, or contains, a random number generator of suitable quality to generate a “guaranteed” unique identifier. An example of such a scheme is the UUID4 identifier. Other identifier schemes are also valid. This information can be gained also by exploiting certain characteristics of hardware, such as specific fault or test instructions, for example, floating-point division bugs in Pentium™ class processors, AMD x86 processor serial numbers, CPU microcode configurations and so forth.

The temporal ID generator 30 generates identifiers based upon the current time (e.g., some aspect of the current time such as the year, full date, hour/minute/second, Unix-time, etc.) This information is typically obtained from the external time source 16, such as an on-board hardware clock, a software call to a function such as POSIX time( ), GPS (or other positioning system) clock signals, or national broadcast radio clock signals, as non-limiting examples.

The positional ID generator 32 generates identifiers based upon the current position of the device. The positional ID generator 32 takes its information from the positioning unit 18, such as the above-noted GPS or WLAN triangulation, GSM/3G/mobile device base station position triangulation, 3GPP, attitude sensors and/or accelerometers, as non-limiting examples.

As was noted, the foregoing components are not to be construed as constituting a full set of identifier generation components or modules. In general, any unit which can supply information suitable for these devices, as well as others not described, can be used for identifier generation. Non-limiting examples of such units include, but are not limited to, sensors such as temperature sensors, humidity sensors, light meters and camera functionality.

### EXAMPLE BEHAVIOR (1)

In this example there is described typical behavior and messaging that can be seen in a system of interest (one including the node identifier generator component 10). Reference is made to FIG. 2 where the message constructor component 40 of some node requests an ID as part of a SmartSpace insert operation. The message constructor 40 receives a request to insert into a given space 42 the RDF triple (a,b,c). The message constructor 40 requires a unique identifier to be sent along with the above information to the space 42, and makes a Get( ) request with some static information (“12345”) to object1 44. The node ID generator 10 associated with object1 44 returns to the message constructor 40 an identifier based upon the current state of the system and containing (in some processed form) the static information. The message constructor 40 then sends a completed message onward to the space 42 (SIB) for subsequent processing.

### EXAMPLE BEHAVIOR (2)

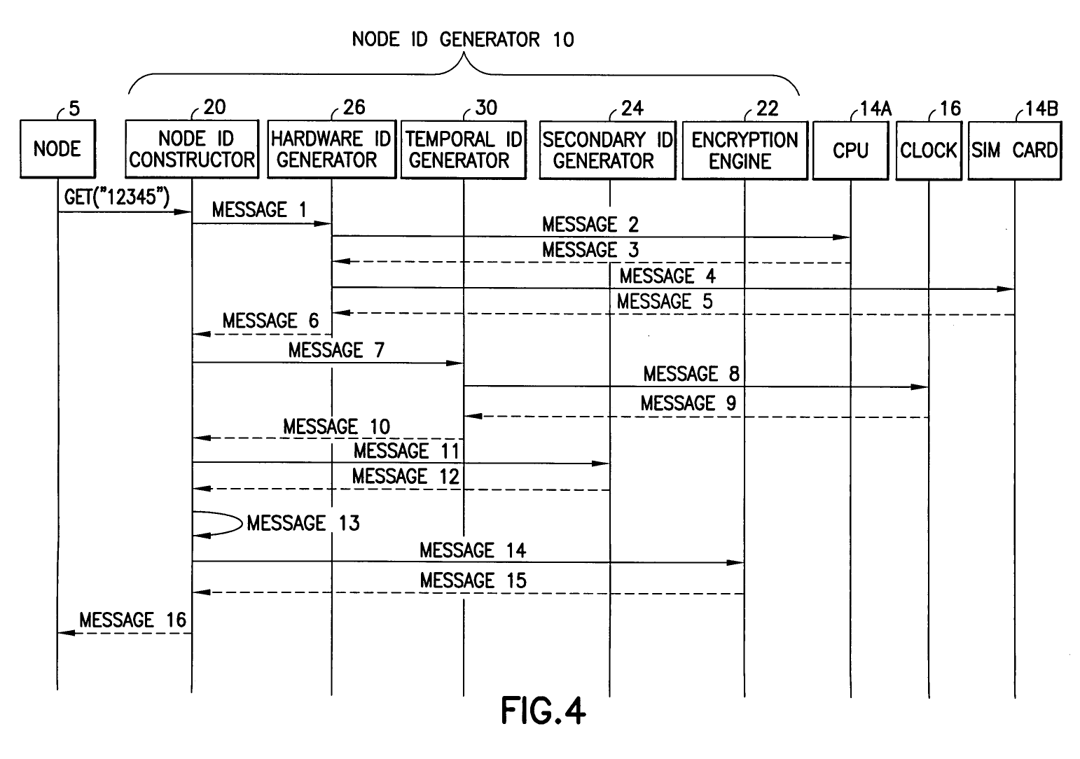

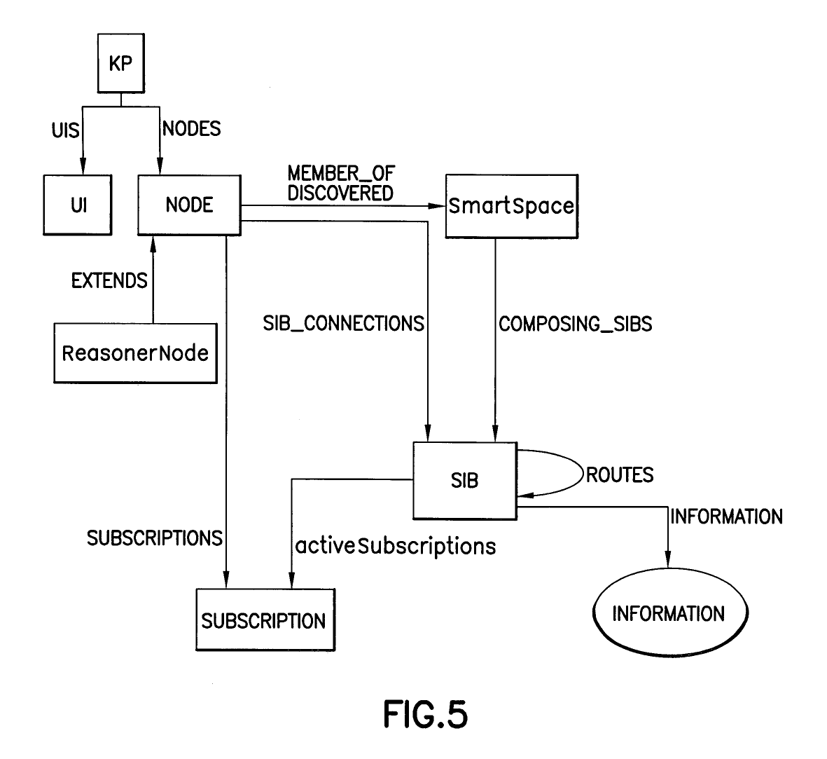

In this additional non-limiting example the internal operation of the various components of the node ID generator 10 shown in FIG. 1 are further explained by the communication between them. The instantiation of this particular unit is shown in FIG. 3, and the exemplary message flow is shown in FIG. 4. Note in FIG. 4 that the instantiation of the hardware component 14 is shown twice, once as the CPU 14A, and once as the SIM card 14B.

Initially node 5 makes the call Get(“12345”) in order to receive a node identifier. The following messages are numbered as Message x, where x is a number 1-16 in the message flow diagram shown in FIG. 4. An explanation of each of the Messages 1-16 is as follows:

1. Call to the hardware ID generator 26 to return an identifier
2. Call to the CPU 14A to return (in this example) its serial number
3. Return of the CPU 14A serial number in an internal/device specific format
4. Call to the SIM card 14B in the device for its serial number
5. Return of the SIM Card 14B serial number in an internal/device specific format
6. Return of the hardware identifier in some node generator format (see below)
7. Call to the temporal ID generator 30 for the current time
8. Call to the hardware clock 16 in the system
9. Return of the time in some internal format, e.g.: 32-bits containing the BIOS date
10. Return of the time in some node generator format (see below)
11. Call to the secondary ID generator with parameters (“12345”)
12. Return of the secondary ID (see below)
13. Processing of the returned information by the node ID constructor 20
14. Passing of the processed information to the encryption engine 22
15. Return of the encrypted information to the node ID constructor 20
16. Return of the final unique (meaningful) identifier to the node 5

The identifier returned to the node ID constructor 20 from the hardware ID generator 26 may take the following form, if represented using XML:

<hardware id>
<cpu serial number = “abcdef”>
<simcard number = “eeeeee”>
</hardware id>

The identifier returned to the node ID constructor 20 from the temporal ID generator 30 may take the following form, if represented using XML:

<temporal id>
<time = 20:31:28>
<date = 18/6/2007>
<timezone = GMT+2>
</temporal id>

Note that in both examples above the hardware ID generator 26 and temporal ID generator 30 process the incoming information from their respective sources 14, 16 in order to produce a format that is usable and understandable by the node ID constructor 20.

The actual functionality of the secondary ID generator 24 is relatively unconstrained. For example, in one non-limiting embodiment it takes the parameters supplied using the Get( ) call to the node ID constructor 20 of the node ID generator 10 and processes the parameters with (potentially) some statically coded information. In this example the return may take the form:

<secondary_id=12345_aaaaa>,
where “aaaaa” represents the potentially statically coded information.

The node ID constructor 20 performs some function on all of the returned information. In one non-limiting embodiment the function may be a simple concatenation of the information, while another, more complex function may be to further refine and process the information to produce the identifier. For example, the node ID constructor 20 may perform concatenation and MD5 production. MD5 (Message-Digest algorithm 5) is a widely used, partially insecure cryptographic hash function with a 128 bit hash value.

In this non-limiting example the node ID constructor 20 concatenates the information received from the various components of the node ID generator 10 and computes a suitable hashing function (e.g., a MD5 hashing function) over the concatenation:

C: = “<hardware id><cpu serial number1 = “abcdef”>
<simcard number = “eeeeee”></hardware id><temporal id>
<time = 20:31:28><date = 18/6/2007><timezone
= GMT+2></temporal id><secondary_id = 12345_aaaaa>”
H: = hash_as_md5(C)

The value in H may then be passed to the encryption engine 22 (message 14 in FIG. 4) which returns an encrypted form of H (message 15) which can be following:

Encrypt(H)=“f2fedbcf87487dafcbed762374fadfafde010182387213bcfdeb345b62f2deaf”

This encrypted value is returned to the node 5 and used in whatever way necessary, typically as the node ID (highlighted below) in some message to the space 42 (e.g., an SSAP message to a SmartSpace), for example:

```
<SSAP_message>
  <transaction_type>INSERT</transaction_type>
  <message_type>REQUEST</message_type>
  <transaction_id>62355249-9807-4c91-95ff-21640cebc266</transaction_id>
  <node_id> f2fedbcf87487dafcbed762374fadfafde010182387213bcfdeb345b62f2deaf
    </node_id>
<space_id>x</space_id>
<parameter name = “triples” type = “rdf-m3”>
```

Further with regard to the uses of these exemplary embodiments, the RDF standard defines the notion of blank node. As all nodes in an RDF graph must be uniquely identified this means that a “blank node” has a uniquely generated identifier. Using the exemplary embodiments of this invention it is possible to generate unique identifiers that contain encoded information. Such information can then only be read by certain parties having knowledge of the required decryption key. This is fully within the remit, scope and official-definition of the universal resource identifier scheme.

Such an RDF triple is described below using the XML representation; where the generated identifier is highlighted:

<subject>http://hss.nrc.nokia.com/hssuser#10c191a5-d0d5-4cf7-9694-
83d7ab28fb35</subject><predicate>!rdf:type</predicate>
<object type = “uri”>
http://hss.nrc.nokia.com/hssuser#FamilyMember</object>

Note the addition of the generated identifier to the namespace declaration.

As should be appreciated, this describes a method of “secretly” encoding meta-information or other information into the URI of a node, such as a blank RDF node.

Described now are examples of instantiated messages. In these example messages the generated node_id is highlighted. Also highlighted are other identifiers which may be generated in the same or similar manner, in accordance with the exemplary embodiments of this invention.

### MESSAGE EXAMPLE 1

```
<SSAP_message>
  <transaction_type>INSERT</transaction_type>
  <message_type>REQUEST</message_type>
  <transaction_id>62355249-9807-4c91-95ff-21640cebc266</transaction_id>
  <node_id>1ddcb584-96e4-49e1-a901-7e2cf1d1e642_bootHSS</node_id>
  <space_id>x</space_id>
  <parameter name = “triples” type = “rdf-m3”>
    <triple_list>
      <triple tag = “0”>
        <subject>http://hss.nrc.nokia.com/hssuser#FamilyMember</subject>
        <predicate>!rdfs:subClassOf</predicate>
        <object type = “uri”>http://hss.nrc.nokia.com/hssuser#HomeMember</object>
      </triple>
      <triple tag = “1”>
        <subject>http://hss.nrc.nokia.com/hssuser#FamilyMember</subject>
        <predicate>!rdf:type</predicate>
        <object type = “uri”>!rdfs:Class</object>
      </triple>
      <triple tag = “2”>
        <subject>http://hss.nrc.nokia.com/hssuser#HomeMember</subject>
        <predicate>!rdf:type</predicate>
        <object type = “uri”>!rdfs:Class</object>
      </triple>
      <triple tag = “3”>
        <subject>http://hss.nrc.nokia.com/hssuser#Visitor</subject>
        <predicate>!rdfs:subClassOf</predicate>
        <object type = “uri”>http://hss.nrc.nokia.com/hssuser#HomeMember</object>
      </triple>
    </triple_list>
  </parameter>
  <parameter name = “confirm”>
    True
  </parameter>
</SSAP_message>
```

### MESSAGE EXAMPLE 2

<SSAP_message><transaction_type>INSERT</transaction_type><message_type>
REQUEST</message_type><transaction_id>bc5c694a-2406-427c-8193-7b58a4e7442a
</transaction_id><node_id>1ddcb584-96e4-49e1-a901-7e2cf1d1e642_bootHSS
</node_id><space_id>x</space_id><parameter name = “triples” type =
“rdf-m3”><triple_list><triple tag = “0”> <subject>
http://hss.nrc.nokia.com/mediaCDS#MediaTrack</subject><predicate>!rdfs:subClassOf
</predicate><object type = “uri”>
http://hss.nrc.nokia.com/mediaCDS#MediaItem</object></triple><triple tag =
“1”><subject>http://hss.nrc.nokia.com/mediaCDS#MediaTrack</subject><predicate>
!rdf:type</predicate><object type = “uri”>!rdfs:Class</object></triple><triple tag =
“2”><subject>http://hss.nrc.nokia.com/mediaCDS#MediaItem</subject><predicate>
!rdf:type</predicate><object type = “uri”>!rdfs:Class</object></triple><triple tag =
“3”><subject>http://hss.nrc.nokia.com/mediaCDS#MediaItem</subject><predicate>
!rdfs:subClassOf</predicate><object type =
“uri”>http://hss.nrc.nokia.com/mediaCDS#MediaObject</object></triple><triple tag =
“4”><subject>http://hss.nrc.nokia.com/mediaCDS#MediaItem</subject><predicate>
!rdf:type</predicate><object type = “uri”>!rdfs:Class</object></triple><triple tag =
“5”><subject>http://hss.nrc.nokia.com/mediaCDS#MediaObject</subject><predicate>
!rdf:type</predicate><object type =
“uri”>!rdfs:Class</object></triple></triple_list></parameter><parameter name =
“confirm”>True</parameter></SSAP_message>

The forgoing message elements, construction and syntax are deemed to be illustrative and exemplary, and are not intended to be construed as restricting in any manner the scope and use of the exemplary embodiments of this invention.

It can be noted that there may be different latencies in the response times of the various units shown in FIG. 1. For example, the response of the temporal ID generator 30 and/or the hardware ID generator 26 may be microseconds, while the response time of the positional ID generator 32 may be milliseconds or seconds, depending on the nature of the positioning unit 18. These latency differences may be mitigated by caching (storing) certain results, such as a last known position, and in response to a time-out occurring (e.g., when the requested information cannot be found) substituting suitable other information in its place.

One non-limiting advantage that may be realized by the use of these exemplary embodiments is that the identifier structure returned may be highly structured and readable by systems capable of supporting semantic web constructs (as well as those systems that do not). The identifier may also be encrypted, giving a degree of protection to the identifier such that systems that cannot use the identifier information or read the information contained within the identifier can still use the identifier and guarantee its uniqueness.

Based on the foregoing it should be apparent that the exemplary embodiments of this invention provide a method, apparatus and computer program(s) to generate a structured and possibly encrypted identifier of a node, such as a node configured to be coupled with a space containing information brokers and other nodes.

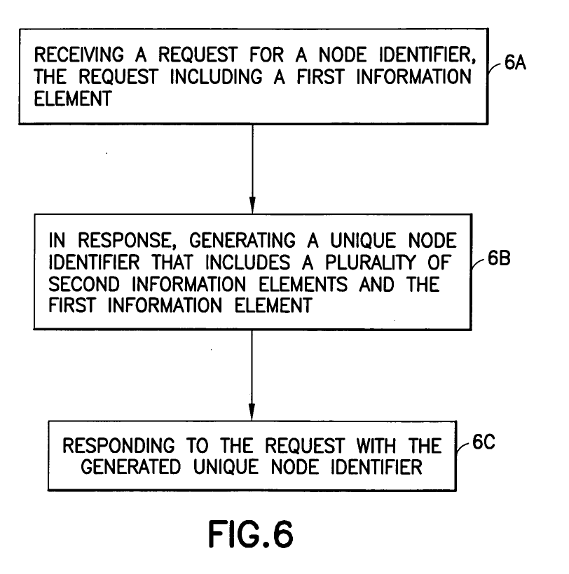

Referring to FIG. 6, a method in accordance with these exemplary embodiments thus includes (Block 6A) receiving a request for a node identifier, the request including a first information element; (Block 6B) in response, generating a unique node identifier that includes a plurality of second information elements and the first information element; and (Block 6C) responding to the request with the generated unique node identifier.

The method of the preceding paragraph, where the first information element comprises static information.

The method of the preceding paragraphs, further comprising encrypting the generated unique node identifier.

The method of the preceding paragraphs, where the second information elements comprise a temporal information element.

The method of the preceding paragraphs, where the second information elements comprise a serial number associated with the node.

The method of the preceding paragraphs, where the second information elements comprise a random number.

The method of the preceding paragraph, where the random number is a universal unique identifier.

The method of the preceding paragraphs, where the second information elements comprise a value obtained from a characteristic of a data processor or a data processor instruction set associated with the node.

The method of the preceding paragraphs, where the second information elements comprise a value obtained from a hardware element that forms a part of, or that is coupled with, the node.

The method of the preceding paragraphs, where the second information elements comprise a value obtained from a sensor.

The method of the preceding paragraphs, where generating comprises executing a function using the plurality of second information elements and the first information element.

The method of the preceding paragraph, where the function is concatenation.

The method of the preceding two paragraphs, further comprising executing a hashing operation on a result of the execution of the function.

The method of the preceding paragraph, further comprising encrypting a result of the hashing function.

The method of the preceding paragraphs, where in response to responding further comprising including the generated unique node identifier in a message.

The method of the preceding paragraph, further comprising sending the message to a semantic information broker.

The method of the preceding paragraphs, where the message is a smartspace application protocol message.

The method of the preceding paragraphs, where the message is a resource description framework message.

The method of the preceding paragraph, where the resource description framework message is associated with a blank node.

The various blocks shown in FIG. 6 may be viewed as method steps, and/or as operations that result from operation of computer program code stored in a computer-readable media (e.g., the program 2A stored in the memory 2), and/or as a plurality of coupled logic circuit elements constructed to carry out the associated function(s).

These exemplary embodiments also encompass an apparatus that includes means for receiving a request for a node identifier, the request including a first information element; means, responsive to the request, for generating a unique node identifier that includes a plurality of second information elements and the first information element; and means for responding to the request with the generated unique node identifier.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. The various embodiments may be implemented at least partially by computer program instructions that are stored or otherwise embodied in computer-readable memory media, such as semiconductor or disk-based memory devices or modules or systems.

While various aspects of the exemplary embodiments of this invention may be illustrated and described as block diagrams, logic flow diagrams, message flow diagrams, or by using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. As such, it should be appreciated that at least some aspects of the exemplary embodiments of the inventions may be practiced in various components such as integrated circuit chips and modules. For example, the node ID generator 10 may be wholly (or partially) implemented within an integrated circuit package, either alone or in combination with other functional units.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context generally of the Semantic Web and RDF, it should be appreciated that the exemplary embodiments of this invention are not limited for use with only these particular types of systems and standards, and that they may be used to advantage in other systems and standards. In addition, the exemplary embodiments of this invention may be used in applications and systems other than the above described SmartSpace and/or the Sedvice applications and systems.

Further, the various names used for the described parameters are not intended to be limiting in any respect, as these parameters may be identified by any suitable names. Further, any formulas and logical expressions, including message formats and the like, that use these various parameters may differ from those expressly disclosed. Further, the various names assigned to different components and units (e.g., node ID constructor, unique ID generator, etc.) are not intended to be limiting in any respect, as these various components and units may be identified by any suitable names.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several nonlimiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method, comprising:
receiving a request for a node identifier, the request including a first information element;
in response, generating a unique node identifier that includes a plurality of second information elements and the first information element; and
responding to the request with the generated unique node identifier.

2. The method of claim 1, where the first information element comprises static information.

3. The method of claim 1, further comprising encrypting the generated unique node identifier.

4. The method of claim 1, where the second information elements comprise a temporal information element.

5. The method of claim 1, where the second information elements comprise a serial number associated with the node.

6. The method of claim 1, where the second information elements comprise a random number.

7. The method of claim 6, where the random number is a universal unique identifier.

8. The method of claim 1, where the second information elements comprise a value obtained from a characteristic of a data processor or a data processor instruction set associated with the node.

9. The method of claim 1, where the second information elements comprise a value obtained from a hardware element that forms a part of, or that is coupled with, the node.

10. The method of claim 1, where the second information elements comprise a value obtained from a sensor.

11. The method of claim 1, where generating comprises executing a function using the plurality of second information elements and the first information element.

12. The method of claim 11, where the function is concatenation.

13. The method of claim 11, further comprising executing a hashing operation on a result of the execution of the function.

14. The method of claim 13, further comprising encrypting a result of the hashing operation.

15. The method of claim 1, where in response to responding further comprising including the generated unique node identifier in a message.

16. The method of claim 15, further comprising sending the message to a semantic information broker.

17. The method of claim 15, where the message is a smartspace application protocol message.

18. The method of claim 15, where the message is a resource description framework message.

19. The method of claim 18, where the resource description framework message is associated with a blank node.

20. A computer-readable memory media that stores a computer program instructions, where execution of the computer program instructions results in the performance of operations that comprise:
receiving a request for a node identifier, the request including a first information element;
in response, generating a unique node identifier that includes a plurality of second information elements and the first information element; and
responding to the request with the generated unique node identifier.

21. The computer-readable memory media of claim 20, where the first information element comprises static information.

22. The computer-readable memory media of claim 20, further comprising an operation of encrypting the generated unique node identifier.

23. The computer-readable memory media of claim 20, where the second information elements comprise a temporal information element.

24. The computer-readable memory media of claim 20, where the second information elements comprise a serial number associated with the node.

25. The computer-readable memory media of claim 20, where the second information elements comprise a random number.

26. The computer-readable memory media of claim 25, where the random number is a universal unique identifier.

27. The computer-readable memory media of claim 20, where the second information elements comprise a value obtained from a characteristic of a data processor or a data processor instruction set associated with the node.

28. The computer-readable memory media of claim 20, where the second information elements comprise a value obtained from a hardware element that forms a part of, or that is coupled with, the node.

29. The computer-readable memory media of claim 20, where the second information elements comprise a value obtained from a sensor.

30. The computer-readable memory media of claim 20, where the operation of generating comprises executing a function using the plurality of second information elements and the first information element.

31. The computer-readable memory media of claim 30, where the function is concatenation.

32. The computer-readable memory media of claim 30, further comprising executing a hashing operation on a result of the execution of the function.

33. The computer-readable memory media of claim 32, further comprising encrypting a result of the hashing operation.

34. The computer-readable memory media of claim 20, where in response to responding further comprising including the generated unique node identifier in a message.

35. The computer-readable memory media of claim 34, further comprising sending the message to a semantic information broker.

36. The computer-readable memory media of claim 34, where the message is a smartspace application protocol message.

37. The computer-readable memory media of claim 34, where the message is a resource description framework message.

38. The computer-readable memory media of claim 37, where the resource description framework message is associated with a blank node.

39. An apparatus, comprising:
a receiver configured to receive a request for a node identifier, the request including a first information element;
a generator configured to respond to the received request to produce a unique node identifier that includes a plurality of second information elements and the first information element; and
a transmitter configured to send the generated unique node identifier.

40. The apparatus of claim 39, where the first information element comprises static information.

41. The apparatus of claim 39, further comprising an encryption engine configured to encrypt the generated unique node identifier prior to the identifier being sent.

42. The apparatus of claim 39, where the second information elements comprise at least one of a temporal information element, a serial number associated with the node, a random number, a value obtained from a characteristic of a data processor or a data processor instruction set, a value obtained from a hardware element that forms a part of, or that is coupled with, the node, and a value obtained from a sensor.

43. The apparatus of claim 42, where the random number is a universal unique identifier.

44. The apparatus of claim 39, where said generator is configured to execute a function using the plurality of second information elements and the first information element.

45. The apparatus of claim 44, where the function is concatenation.

46. The apparatus of claim 44, said generator being further configured to execute a hashing operation on a result of the execution of the function.

47. The apparatus of claim 46, further comprising an encryption engine configured to encrypt a result of the hashing operation prior to the identifier being sent.

48. The apparatus of claim 39, where the generated unique node identifier is included as part of a message that is sent by said transmitter.

49. The apparatus of claim 48, where said transmitter sends the message to a semantic information broker.

50. The apparatus of claim 48, where the message is a smartspace application protocol message.

51. The apparatus of claim 48, where the message is a resource description framework message.

52. The apparatus of claim 51, where the resource description framework message is associated with a blank node.
